(19) United States
(12) Patent Application Publication
(10) Pub. No.: US 2008/0003435 A1
(43) Pub. Date: Jan. 3, 2008

(54) Faux fibers and fibrous structures employing same

(75) Inventors: Arnold William Trueman, Cedar Grove, TN (US); Kenneth Douglas Vinson, Toone, TN (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/820,613

(22) Filed: Jun. 20, 2007

Related U.S. Application Data
(60) Provisional application No. 60/817,304, filed on Jun. 29, 2006.

(51) Int. Cl. B32B 9/00; D02G 3/00

(52) U.S. Cl. 428/394; 264/640; 428/392

(57) ABSTRACT

Faux fibers, more particularly faux fibers including a dye, methods for making such faux fibers and fibrous structures employing such faux fibers are provided.

### CROSS REFERENCE TO RELATED APPLICATION

This application claims the benefit of U.S. Provisional Application No. 60/817,304 filed Jun. 29, 2006.

### FIELD OF THE INVENTION

The present invention relates to faux fibers, more particularly to faux fibers comprising a dye, methods for making such faux fibers and fibrous structures employing such faux fibers.

### BACKGROUND OF THE INVENTION

Fibrous structures and/or sanitary tissue products comprising fibrous structures have included colored materials. For example, some fibrous structures and/or sanitary tissue products have utilized colored glue and/or dyes to offer consumers colored sanitary tissue products. Other fibrous structures and/or sanitary tissue products have utilized printing to impart color. Some have even included dyed fibers. All of these executions have added costs and hygiene issues.

Accordingly, there is a need for a fibrous structure and/or sanitary tissue product that aesthetically looks like it contains dyed fibers without the costs and hygiene issues associate therewith.

### SUMMARY OF THE INVENTION

The present invention fulfills the needs described above by providing a dyed faux fiber (in other words, a dye composition that is applied to a fibrous structure to look like a fiber), fibrous structures employing same and methods for making same.

In one example of the present invention, a faux fiber comprising a dye is provided.

In another example of the present invention, a fibrous structure comprising a faux fiber and/or a fiber wherein the faux fiber and/or fiber is associated with a certain ingredient (other than the fact that the faux fiber and/or fiber is present) and/or a certain characteristic of the fibrous structure, is provided.

In yet another example of the present invention, a method for making a fibrous structure, the method comprising the step of applying a faux fiber composition comprising a dye to a surface of a fibrous structure wherein the dye is associated with an ingredient and/or characteristic of the fibrous structure such that a consumer is able to determine by looking at the faux fiber that the fibrous structure and/or sanitary tissue product comprising such fibrous structure contains a certain ingredient and/or exhibits a certain characteristic, is provided.

In another example of the present invention, a method for making a fibrous structure, the method comprising the step of incorporating a fiber into a fibrous structure, wherein the fiber is associated with an ingredient and/or characteristic of the fibrous structure such that a consumer is able to determine by looking at the fiber that the fibrous structure and/or sanitary tissue product comprising such fibrous structure contains a certain ingredient and/or exhibits a certain characteristic, is provided.

In another example of the present invention, a fibrous structure comprising one or more fibers and one or more faux fibers, is provided.

In yet another example of the present invention, a method for making a faux fiber comprises the step of depositing a faux fiber composition comprising a dye onto a substrate, such as a fibrous structure, to form a faux fiber, is provided.

In still another example of the present invention, a method for making a fibrous structure comprising a faux fiber, the method comprising the step of applying a faux fiber composition comprising a dye to a surface of a fibrous structure such that a faux fiber is produced, is provided.

Accordingly, the present invention provides a faux fiber, a method for making a faux fiber, a fibrous structure comprising a faux fiber and a method for making such a fibrous structure.

### BRIEF DESCRIPTION OF THE DRAWINGS

FIG. 1 is a schematic representation of a fibrous structure in accordance with the present invention.

### DETAILED DESCRIPTION OF THE INVENTION

### Definitions

“Faux fiber” as used herein means a material that resembles, to a consumer, a fiber even though it is not a fiber. In one example the faux fiber comprises a dye. In another example, the faux fiber comprises a dye and a polymer. The faux fiber may exhibit a length of at least about 1 mm. The faux fiber may exhibit any shape, for example it may be ribbon-shaped.

In one example, the faux fiber comprises a dye and a polymer in a weight ratio of at least about 1:1 and/or at least about 2:1 and/or at least about 5:1 and/or at least about 15:1 and/or at least about 25:1 and/or at least about 50:1 and/or at least about 100:1 and/or at least about 200:1.

“Faux fiber composition” as used herein means one or more materials that are capable of forming a faux fiber. For example, a dye composition that is capable of being applied to a fibrous structure to visually look like a fiber to a consumer.

“Fiber” as used herein means an elongate particulate having an apparent length greatly exceeding its apparent width, i.e. a length to diameter ratio of at least about 10. Fibers have some integrity, i.e. manifested by some intrinsic strength. If an apparent elongate particulate, supported by a substrate, fails to have enough instrinsic strength to support itself, it is not a fiber, but may be a faux fiber. More specifically, as used herein, “fiber” refers to papermaking fibers. The present invention contemplates the use of a variety of papermaking fibers, such as, for example, natural fibers or synthetic fibers, or any other suitable fibers, and any combination thereof. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. U.S. Pat. No. 4,300,981 and U.S. Pat. No. 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking.

In addition to the various wood pulp fibers, other cellulosic fibers such as cotton linters, rayon, and bagasse can be used in this invention. Synthetic fibers and/or non-naturally occurring fibers, such as polymeric fibers, can also be used. Elastomeric polymers, polypropylene, polyethylene, polyester, polyolefin, and nylon, can be used. The polymeric fibers can be produced by spunbond processes, meltblown processes, and other suitable methods known in the art.

An embryonic fibrous web can be typically prepared from an aqueous dispersion of papermaking fibers, though dispersions in liquids other than water can be used. The fibers are dispersed in the carrier liquid to have a consistency of from about 0.1 to about 0.3 percent. It is believed that the present invention can also be applicable to moist forming operations where the fibers are dispersed in a carrier liquid to have a consistency of less than about 50% and/or less than about 10%.

“Fibrous structure” as used herein means a structure that comprises one or more fibers. In one example, a fibrous structure according to the present invention means an orderly arrangement of fibers within a structure in order to perform a function. Nonlimiting examples of fibrous structures of the present invention include composite materials (including reinforced plastics and reinforced cement), paper, fabrics (including woven, knitted, and non-woven), and absorbent pads (for example for diapers or feminine hygiene products). A bag of loose fibers is not a fibrous structure in accordance with the present invention.

Nonlimiting examples of processes for making fibrous structures include known wet-laid papermaking processes and air-laid papermaking processes. Such processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous suspension is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product.

The fibrous structures of the present invention may be homogeneous or may be layered. If layered, the fibrous structures may comprise at least two and/or at least three and/or at least four and/or at least five layers.

“Sanitary tissue product” as used herein means a soft, low density (i.e. <about 0.15 g/cm3) web useful as a wiping implement for post-urinary and post-bowel movement cleaning (toilet tissue), for otorhinolaryngological discharges (facial tissue), and multi-functional absorbent and cleaning uses (absorbent towels). The sanitary tissue product may be convolutedly wound upon itself about a core or without a core to form a roll of sanitary tissue product.

In one example, the sanitary tissue product of the present invention comprises a fibrous structure according to the present invention.

“Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121.

“Basis Weight” as used herein is the weight per unit area of a sample reported in lbs/3000 ft² or g/m². Basis weight is measured by preparing one or more samples of a certain area (m²) and weighing the sample(s) of a fibrous structure according to the present invention and/or a paper product comprising such fibrous structure on a top loading balance with a minimum resolution of 0.01 g. The balance is protected from air drafts and other disturbances using a draft shield. Weights are recorded when the readings on the balance become constant. The average weight (g) is calculated and the average area of the samples (m²). The basis weight (g/m²) is calculated by dividing the average weight (g) by the average area of the samples (m²).

“Machine Direction” or “MD” as used herein means the direction parallel to the flow of the fibrous structure through the papermaking machine and/or product manufacturing equipment.

“Cross Machine Direction” or “CD” as used herein means the direction perpendicular to the machine direction in the same plane of the fibrous structure and/or paper product comprising the fibrous structure.

“Ply” or “Plies” as used herein means an individual fibrous structure optionally to be disposed in a substantially contiguous, face-to-face relationship with other plies, forming a multiple ply fibrous structure. It is also contemplated that a single fibrous structure can effectively form two “plies” or multiple “plies”, for example, by being folded on itself.

### As used herein, the articles “a” and “an” when used herein, for example, “an anionic surfactant” or “a fiber” is understood to mean one or more of the material that is claimed or described.

All percentages and ratios are calculated by weight unless otherwise indicated. All percentages and ratios are calculated based on the total composition unless otherwise indicated.

Unless otherwise noted, all component or composition levels are in reference to the active level of that component or composition, and are exclusive of impurities, for example, residual solvents or by-products, which may be present in commercially available sources.

### Fibrous Structure

The fibrous structures of the present invention may comprise one or more faux fibers.

When present, the fibrous structure may comprise at least about 0.01% by weight, on a dry fibrous structure basis of a faux fiber. In one example, the fibrous structure may comprise at least about 0.01% and/or at least about 0.02% and/or at least about 0.04% and/or at least about 0.06% to about 5% and/or to about 3% and/or to about 1.5% and/or to about 1% by weight, on a dry fibrous structure basis of a faux fiber.

In addition to the faux fiber, the fibrous structures of the present invention may comprise one or more fibers. In addition to the faux fiber and fibers, the fibrous structures of the present invention may comprise any suitable ingredients known in the art. Nonlimiting examples of suitable ingredients that may be included in the fibrous structures include permanent and/or temporary wet strength resins, dry strength resins, softening agents, wetting agents, lint resisting agents, absorbency-enhancing agents, immobilizing agents, especially in combination with emollient lotion compositions, antiviral agents including organic acids, antibacterial agents, polyol polyesters, antimigration agents, polyhydroxy plasticizers, opacifying agents and mixtures thereof. Such ingredients, when present in the fibrous structure of the present invention, may be present at any level based on the dry weight of the fibrous structure. Typically, such ingredients, when present, may be present at a level of from about 0.001 to about 50% and/or from about 0.001 to about 20% and/or from about 0.01 to about 5% and/or from about 0.03 to about 3% and/or from about 0.1 to about 1.0% by weight, on a dry fibrous structure basis.

The fibrous structures of the present invention may be of any type, including but not limited to, conventionally felt-pressed fibrous structures; pattern densified fibrous structures; and high-bulk, uncompacted fibrous structures. The fibrous structures may be creped or uncreped and/or through-dried or conventionally dried. The sanitary tissue products made therefrom may be of a single-ply or multi-ply construction.

The fibrous structures of the present invention and/or sanitary tissue products comprising such fibrous structures may have a basis weight of between about 10 g/m² to about 120 g/m² and/or from about 14 g/m² to about 80 g/m² and/or from about 20 g/m² to about 60 g/m².

The fibrous structures of the present invention and/or sanitary tissue products comprising such fibrous structures may have a total dry tensile strength of greater than about 59 g/cm (150 g/in) and/or from about 78 g/cm (200 g/in) to about 394 g/cm (1000 g/in) and/or from about 98 g/cm (250 g/in) to about 335 g/cm (850 g/in).

The fibrous structures of the present invention and/or sanitary tissue products comprising such fibrous structures may have a density of about 0.60 g/cc or less and/or about 0.30 g/cc or less and/or from about 0.04 g/cc to about 0.20 g/cc.

The fibrous structures of the present invention may natural fibers, non-naturally occurring fibers, such as spun cellulose fibers, and/or synthetic fibers.

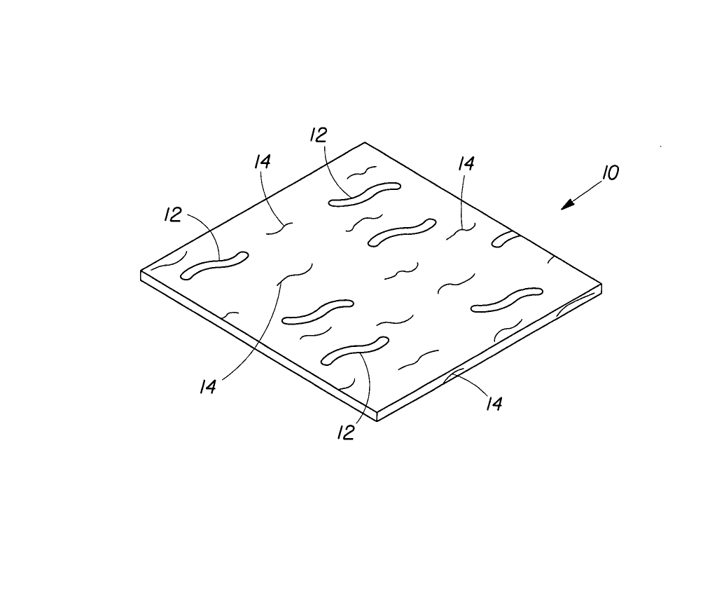

As shown in FIG. 1, a fibrous structure 10 comprises one or more faux fibers 12. The fibrous structure 10 also comprises one or more fibers 14.

### Faux Fiber Composition

Any suitable faux fiber composition may be used to form the faux fiber. In one example, the dye composition comprises from about 50% to about 99.9% by weight of the composition of water; from about 0.1% to about 50% by weight of the composition of a dye, and optionally from about 0.0005% to about 50% by weight of the composition of a polymer.

In another example, water may comprise from about 60% to about 99.9% and/or from about 70% to about 95% by weight of the faux fiber composition.

In yet another example, a dye may comprise from about 0.5% to about 50% and/or from about 1% to about 45% and/or from about 5% to about 45% by weight of the faux fiber composition.

In even yet another example, a polymer may comprise from about 0.05% to about 25% and/or from about 0.1% to about 10% and/or from about 0.2% to about 5% by weight of the faux fiber composition.

### Dye

Any suitable dye known in the art may be used in the faux fiber composition. In one example, the dye is water-soluble. The dye may be of any color. It may be a non-white color. It may be a primary color. Nonlimiting examples of suitable colors include green, yellow, blue and peach. Nonlimiting examples of suitable dyes include Kemira direct dyes available commercially from Kemira Corporation of Kennesaw, Ga., for example, Pontamine Fast Turquoise 8GL liquid and/or Pontamine Yellow 711 liquid.

### Polymer

Any suitable polymer known in the art may be used in the faux fiber composition. High molecular weight polymers (hereinafter “high polymers”) soluble in the faux fiber composition are preferred since the high molecular weight and extended chain form of the polymer tend to provide more stringiness character to the faux fiber composition and therefore can be effective in lesser amounts; however any polymer compatible with the faux fiber composition may be used. The term “soluble” means that the high polymer appears to dissolve in faux fiber composition in that it disperses with no obvious phase separation.

In one embodiment, the polymer preferably has a substantially linear chain structure, though a linear chain having short (C₁-C₃) branches or a branched chain having one to three long branches are also suitable for use herein).

Without being bound by theory, it is believed that polymers suitable for use herein provide the composition with extensibility preventing fracture of the composition as it is propelled from a spray apparatus to a substrate, e.g. a fibrous structure. It is believed that this extensibility causes a “stringiness” of the faux fiber composition and the string-like form is preserved so that deposits appear to be fibers after deposition even though they are not true fibers.

The polymers useful herein are preferably high molecular weight, substantially linear chain molecules. Preferably the polymer will have a weight-average molecular weight of at least 500,000. Typically the weight average molecular weight of the polymer ranges from about 500,000 to about 25,000,000, more typically from about 800,000 to about 22,000,000, even more typically from about 1,000,000 to about 20,000,000, and most typically from about 2,000,000 to about 15,000,000.

Nonlimiting examples of suitable high polymers include polyacrylamide and derivatives such as carboxyl modified polyacrylamide; acrylic polymers and copolymers including polyacrylic acid, polymethacrylic acid, and their partial esters; vinyl polymers including polyvinyl alcohol, polyvinylacetate, polyvinylpyrrolidone, polyethylene vinyl acetate, polyethyleneimine, and the like; polyamides; polyalkylene oxides such as polyethylene oxide, polypropylene oxide, polyethylene/propylene oxide, and mixtures thereof. Copolymers made from mixtures of monomers selected from any of the aforementioned polymers are also suitable herein. Other exemplary high polymers include water soluble polysaccharides such as alginates, carrageenans, pectin and derivatives, chitin and derivatives, and the like; gums such as guar gum, xanthum gum, agar, gum arabic, karaya gum, tragacanth gum, locust bean gum, and like gums; water soluble derivatives of cellulose, such as alkylcellulose, hydroxyalkylcellulose, carboxyalkylcellulose, and the like; and mixtures thereof.

Some polymers (e.g., polyacrylic acid, polymethacrylic acid) are generally not available in the high molecular weight range (i.e., 500,000 or higher). A small amount of crosslinking agents may be added to create branched polymers of suitably high molecular weight useful herein.

The high polymer, when used in a spraying process, is added to the composition of the present invention in an amount effective to visibly reduce shear fracture and the resulting aerosolization during the spraying process such that substantially all of the faux fiber composition is deposited onto the tissue web. These polymers, when used, are typically present in the range from about 0.01 to about 5 wt %, more typically from about 0.01 to about 2 wt %, even more typically from about 0.01 to about 1 wt %, and most typically from about 0.05 to about 0.5 wt % of the composition. A particularly preferred range is between about 0.1 wt % and about 0.25 wt %.

Suitable polymers include Magnafloc E-30, a non-ionic polyacrylamide and Percol E-20, a cationic polyacrylamide both are products of Ciba Specialty Chemicals of Tarrytown, N.Y.

### Faux Fiber

The faux fiber is formed in and/or on a surface of a fibrous structure. The faux fiber of the present invention comprises a dye. Suitable dyes are described herein. The faux fiber may further comprise a polymer. Suitable polymers are described herein.

The faux fiber may be associated with an ingredient and/or characteristic of the fibrous structure. For example, a certain color of a faux fiber may indicate to consumers that the fibrous structure and/or sanitary tissue product comprising such fibrous structure comprises a certain ingredient and/or may exhibit a certain characteristic (i.e., property). Nonlimiting examples of ingredients include softening agents, perfumes, natural ingredients, such as chamomile, lavender and the like, and/or other suitable ingredients known to those of ordinary skill in the art. Nonlimiting examples of characteristics exhibited by a fibrous structure and/or sanitary tissue product comprising such a fibrous structure include softness, lint, fiber type, absorbency, wet strength, texture and the like, and/or other suitable characteristics known to those of ordinary skill in the art.

Accordingly, the present invention further includes a method for making a fibrous structure comprising the steps of applying a faux fiber composition comprising a dye to a surface of a fibrous structure wherein the dye is associated with an ingredient and/or characteristic of the fibrous structure such that a consumer is able to determine by looking at the faux fiber that the fibrous structure and/or sanitary tissue product comprising such fibrous structure contains a certain ingredient and/or exhibits a certain characteristic. Further, the sanitary tissue product may be associated with packaging which houses the sanitary tissue product, wherein the packaging has visual and/or textual cues to help communicate to a consumer about the presence of an ingredient and/or characteristic.

### Method for Making a Faux Fiber

A faux fiber may be made by any suitable method known in the art. In one example, the method for making a faux fiber comprises the step of depositing a faux fiber composition comprising a dye onto a substrate, such as a fibrous structure, to form a faux fiber.

### Method for Making a Fibrous Structure

A fibrous structure comprising a faux fiber may be made by any suitable method known in the art. In one example, a method for making a fibrous structure comprising a faux fiber comprises the step of applying a faux fiber composition comprising a dye to a surface of a fibrous structure.

In another example, the faux fiber composition is applied to the surface of a fibrous structure when the fibrous structure exhibits a consistency of at least about 70%.

In one example, the faux fiber composition may be applied to the surface of the fibrous structure by a spray applicator. The spray applicator may be associated with an attenuation fluid source, such as air, Room Temperature or heated; liquid; steam; humid air; moist air, and the like, that attenuates the faux fiber composition.

In another example, the faux fiber composition may be applied to the surface of the fibrous structure by extrusion.

In still another example, the faux fiber composition may be applied to the surface of the fibrous structure by printing. The printing may be rotogravure printing.

### Nonlimiting Example

A fibrous structure having a basis weight of 16 g/m2 and a density of 0.125 g/cm³ is conventionally made on a wet laid papermachine. After creping from the Yankee surface, the web is conveyed to a reel at a speed of about 800 feet per minute. A faux fiber is laid upon the top (i.e. non-Yankee) surface of the fibrous structure using an assembly of ITW Dynatec UFD nozzles (made by Illinois Tool Works of Glenview, Ill.) positioned at a point terminating about 10 cm above the fibrous structure. Each of the nozzles has three orifices measuring about 0.010 in.×0.010 in. The center of the three fluid orifices is oriented directly vertical to the path of the fibrous structure, while the outer orifices are angled at 15 degrees relative to vertical. Each fluid orifice has an associated air orifice situated on either side of it, for a total of six air orifices, each measuring about 0.010 in.×0.010 in. The fluid orifice extends 0.5 cm beyond the lower surface of the nozzle. Nozzles are spaced about 5 cm apart and about 10 cm above the fibrous structure while it is being treated. Fluid is directed at the fibrous structure in order to deliver faux fibers to the surface of the fibrous structure. About 7.5 psi of air pressure is sufficient to create a uniformly attenuated spray. The faux fiber composition is about 83% water, 13.2% Turquoise 8GL liquid and 3.5% Yellow 711 dye and 0.17% Magnafloc E-30 polymer. The faux fiber composition is sprayed at a rate of about 2.1 ml/min/nozzle. The moisture carried to the fibrous structure by the faux fiber composition equilibrates into the overdry fibrous structure leaving the dry faux fiber (i.e. dye+polymer, in this case) amounting to about 0.17% by weight of the fibrous structure. Plies of this fibrous structure are combined into a 2-ply sanitary tissue product having an appealing appearance due to the visible strands of faux fiber.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A faux fiber comprising a dye.

2. The faux fiber according to claim 1 wherein the faux fiber further comprises a polymer.

3. The faux fiber according to claim 2 wherein the faux fiber comprises the dye and the polymer in a weight ratio of dye to polymer of at least about 1:1.

4. The faux fiber according to claim 3 wherein the faux fiber comprises the dye and the polymer in a weight ration of dye to polymer of at least about 2:1.

5. The faux fiber according to claim 1 wherein the dye is a non-white color.

6. The faux fiber according to claim 5 wherein the dye comprises a primary color.

7. The faux fiber according to claim 1 wherein the faux fiber exhibits a length of at least about 1 mm.

8. The faux fiber according to claim 1 wherein the faux fiber exhibits a ribbon shape.

9. A fibrous structure comprising one or more fibers and one or more faux fibers according to claim 1.

10. The fibrous structure according to claim 9 wherein the one or more fibers are selected from the group consisting of: natural and/or non-naturally occurring fibers.

11. The fibrous structure according to claim 9 wherein the fibrous structure is a nonwoven fibrous structure.

12. The fibrous structure according to claim 9 wherein the one or more faux fibers visually indicate to a consumer that the fibrous structure contains a certain ingredient and/or exhibits a certain characteristic.

13. A single- or multi-ply sanitary tissue product comprising a fibrous structure according to claim 9.

14. A method for making a fibrous structure comprising a faux fiber, the method comprising the step of applying a faux fiber composition comprising a dye to a surface of a fibrous structure such that a faux fiber is produced.

15. The method according to claim 14 wherein the faux fiber composition further comprises water.

16. The method according to claim 14 wherein the faux fiber composition further comprises a polymer wherein the dye and the polymer are present in the faux fiber composition in a weight ratio of dye to polymer of at least 1:1.

17. The method according to claim 14 wherein the faux fiber composition is applied to the surface of the fibrous structure when the fibrous structure exhibits a consistency of at least about 70%.

18. The method according to claim 14 wherein the faux fiber visually indicates to a consumer that the fibrous structure contains a certain ingredient and/or exhibits a certain characteristic.

19. A method for making a fibrous structure, the method comprising the step of incorporating a faux fiber into a fibrous structure, wherein the faux fiber is associated with a certain ingredient and/or a certain characteristic of the fibrous structure such that a consumer is able to determine by looking at the faux fiber that the fibrous structure and/or sanitary tissue product comprising such fibrous structure contains a certain ingredient and/or exhibits a certain characteristic.
